(19) United States
(12) Patent Application Publication
(10) Pub. No.: US 2012/0320972 A1
(43) Pub. Date: Dec. 20, 2012

(54) APPARATUS AND METHOD FOR LOW-COMPLEXITY OPTIMAL TRANSFORM SELECTION

(75) Inventors: Zhan Ma, Dallas, TX (US); Felix Carlos Fernandes, Plano, TX (US)

(73) Assignee: Samsung Electronics Co., Ltd., Suwon-si (KR)

(21) Appl. No.: 13/494,810

(22) Filed: Jun. 12, 2012

Related U.S. Application Data
(60) Provisional application No. 61/497,845, filed on Jun. 16, 2011.
(60) Provisional application No. 61/557,191, filed on Nov. 8, 2011.
(60) Provisional application No. 61/589,147, filed on Jan. 20, 2012.

(51) Int. Cl. H04N 7/30; H04N 7/50; H04N 7/40

(52) U.S. Cl. 375/240.03; 375/E07.14; 375/E07.211; 375/E07.245

(57) ABSTRACT

A video processing system includes prediction primary transforms, quantization, entropy coding and filtering configured to receive and compress video information and output compressed video information corresponding to the received video information. The compressed video information comprising prediction mode, transform block size, quantization parameter, and filtering type. The video processing system also includes a secondary transform configured to receive and compress the compressed video information. The video processing system also includes a quantization stage configured to receive and compress the transformed coefficients. The video processing system also includes an entropy coding stage configured to convert the compressed video information into binary bits. The video processing system also includes a filtering stage configured to improve the reconstructed video information for better prediction.

### CROSS-REFERENCE TO RELATED APPLICATION(S) AND CLAIM OF PRIORITY

The present application is related to U.S. Provisional Patent Application No. 61/497,845, filed Jun. 16, 2011, entitled “LOW-COMPLEXITY ROTATIONAL TRANSFORM ENCODING”, U.S. Provisional Patent Application No. 61/557,191, filed Nov. 8, 2011, entitled “LOW-COMPLEXITY ROTATIONAL TRANSFORM ENCODING” and U.S. Provisional Patent Application No. 61/589,147, filed Jan. 20, 2012, entitled “LOW-COMPLEXITY ROTATIONAL TRANSFORM ENCODING”. Provisional Patent Application No. 61/497,845, 61/557,191 and 61/589,147 are assigned to the assignee of the present application and is hereby incorporated by reference into the present application as if fully set forth herein. The present application hereby claims priority under 35 U.S.C. §119(e) to U.S. Provisional Patent Application No. 61/497,845, 61/557,191 and 61/589,147.

### TECHNICAL FIELD

The present application relates generally to video processing, more specifically, to an encoder and decoder using low complexity rotational transform.

### BACKGROUND

To effectively compress image/video frames, encoders usually apply orthogonal primary transforms to prediction residual blocks within the frame to compact the energy within each block into a few non-zero transform coefficients and several zero coefficients. Currently, video information is increases in resolution and size. Accordingly, there is an increased burden on the video processing system to transmit more video information over existing wired and wireless communications channels.

### SUMMARY

A video processing system is provided. The video processing system includes prediction primary transforms, quantization and entropy coding and filtering configured to receive and compress video information and output compressed video information corresponding to the received video information. The compressed video information comprising prediction mode, transform block size, quantization parameter, and filtering type. The video processing system also includes a secondary transform configured to receive and compress the compressed video information. The video processing system also includes a quantization stage configured to receive and compress the transformed coefficients. The video processing system also includes an entropy coding stage configured to convert the compressed video information into binary bits. The video processing system also includes a filtering stage configured to improve the reconstructed video information for better prediction.

A method for video processing is provided. The method includes prediction, by spatial or temporal prediction, and transform, by a primary transform. In addition, the method includes compressing, by a secondary transform, the compressed video information, and compressing, by a quantization, converting the transformed coefficients into quantized coefficients. The method also includes converting, by an entropy coding stage, the compressed video information including quantized coefficients and side information (such as prediction mode, transform size, secondary transform type, quantization parameter, and filtering operations), into binary bits. The method also includes filtering, by a filter operation stage, the reconstructed video information.

A video transmission system is provided. The video transmission system includes an encoder configured to compress video information. The encoder includes prediction primary transforms, quantization and entropy coding and filtering configured to receive and compress video information and output compressed video information corresponding to the received video information. The compressed video information comprising prediction mode, transform block size, quantization parameter, and filtering type. The encoder also includes a secondary transform configured to receive and compress the compressed video information. The encoder also includes a quantization stage configured to receive and compress the transformed coefficients. The encoder also includes an entropy coding stage configured to convert the compressed video information into binary bits. The encoder also includes a filtering stage configured to improve the reconstructed video information for better prediction. The video transmission system includes a transmitter is configured to transmit the quantized coefficients.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a wireless communication network according to embodiments of this disclosure;

FIG. 2 illustrates a high-level diagram of an orthogonal frequency division multiple access (OFDMA) transmitter path according to an embodiment of this disclosure;

FIG. 3 illustrates a high-level diagram of an OFDMA receiver path according to an embodiment of this disclosure;

FIG. 4 illustrates an exemplary wireless subscriber station according to embodiments of the present disclosure;

FIG. 5 illustrates an encoder that includes a rotational transform (ROT) based secondary transform according to embodiments of the present disclosure;

FIG. 6 illustrates an encoder that includes a ROT with rate-distortion optimized quantization (RDOQ) loop according to embodiments of the present disclosure

FIG. 7 illustrates an m×m block based rotational transform on an M×M transform block according to embodiments of the present disclosure; and

FIG. 8 illustrates an example zig-zag scanning on a 16×16 block according to embodiments of the present disclosure.

### DETAILED DESCRIPTION

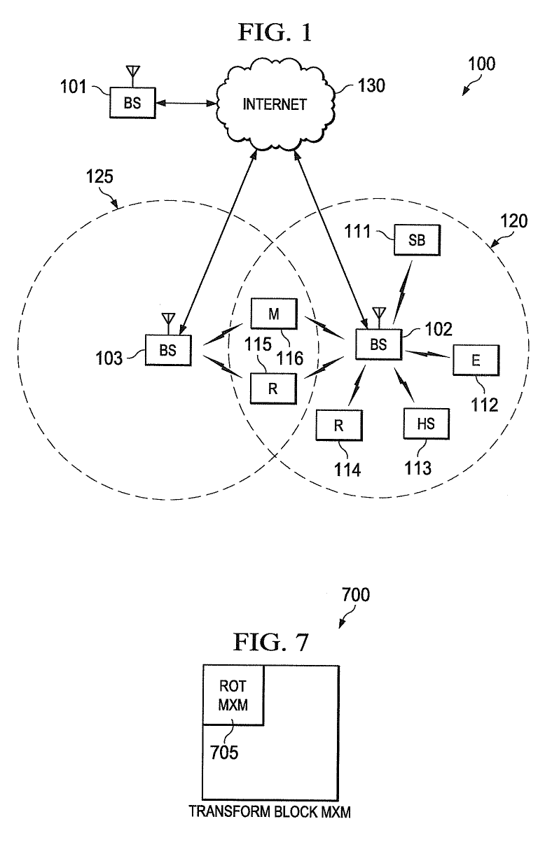

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged video processing system.

To effectively compress image/video frames, encoders apply an orthogonal primary transform to blocks within the prediction residual frame to compact the energy within each block into a few non-zero transform coefficients and several zero coefficients. To increase compression ratio, an orthogonal secondary transform such as the rotational transform (K. McCann, W.-J. Han and I.-K. Kim, “Samsung's Response to the Call for Proposals on Video Compression Technology”, JCT-VC A124, April, 2010, Dresden, Germany, the contents of which are hereby incorporated by reference) is applied after the primary transform to improve quantization performance and the rate-distortion performance. To compact the energy as much as possible, multiple different rotational transforms are developed in addition to the primary transform. A simple implementation is looping all possible rotational transforms and selecting the right one with the best performance. However, such encoding scheme increases computational complexity dramatically. There is a need for low-complexity rotational transform encoding scheme which provides the performance improvement at a reasonable complexity sacrifice

Currently, rate-distortion optimized quantization (RDOQ) is employed in the advanced codec, such as H.264/AVC and on-going MPEG high efficiency video coding (HEVC) to improve the coding efficiency. The Rotational transform has to be implemented inside the RDOQ loop to choose the best one. Thus, RDOQ has to be conducted N+1 times, where N is the number of rotational transform. The computational complexity is unacceptably high for such design.

FIG. 1 illustrates a wireless communication network, according to embodiments of this disclosure. The embodiment of wireless communication network 100 illustrated in. FIG. 1 is for illustration only. Other embodiments of the wireless communication network 100 could be used without departing from the scope of this disclosure.

In the illustrated embodiment, the wireless communication network 100 includes base station (BS) 101, base station (BS) 102, base station (BS) 103, and other similar base stations (not shown). Base station 101 is in communication with base station 102 and base station 103. Base station 101 is also in communication with Internet 130 or a similar IP-based system (not shown).

Base station 102 provides wireless broadband access (via base station 101) to Internet 130 to a first plurality of subscriber stations (also referred to herein as mobile stations) within coverage area 120 of base station 102. The first plurality of subscriber stations includes subscriber station 111, which may be located in a small business (SB), subscriber station 112, which may be located in an enterprise (E), subscriber station 113, which may be located in a WiFi hotspot (HS), subscriber station 114, which may be located in a first residence (R), subscriber station 115, which may be located in a second residence (R), and subscriber station 116, which may be a mobile device (M), such as a cell phone, a wireless laptop, a wireless PDA, or the like.

Base station 103 provides wireless broadband access (via base station 101) to Internet 130 to a second plurality of subscriber stations within coverage area 125 of base station 103. The second plurality of subscriber stations includes subscriber station 115 and subscriber station 116. In an exemplary embodiment, base stations 101-103 may communicate with each other and with subscriber stations 111-116 using OFDM or OFDMA techniques.

While only six subscriber stations are depicted in FIG. 1, it is understood that the wireless communication network 100 may provide wireless broadband access to additional subscriber stations. It is noted that subscriber station 115 and subscriber station 116 are located on the edges of both coverage area 120 and coverage area 125. Subscriber station 115 and subscriber station 116 each communicate with both base station 102 and base station 103 and may be said to be operating in handoff mode, as known to those of skill in the art.

Subscriber stations 111-116 may access voice, data, video, video conferencing, and/or other broadband services via Internet 130. For example, subscriber station 116 may be any of a number of mobile devices, including a wireless-enabled laptop computer, personal data assistant, notebook, handheld device, or other wireless-enabled device. Subscriber stations 114 and 115 may be, for example, a wireless-enabled personal computer (PC), a laptop computer, a gateway, or another device.

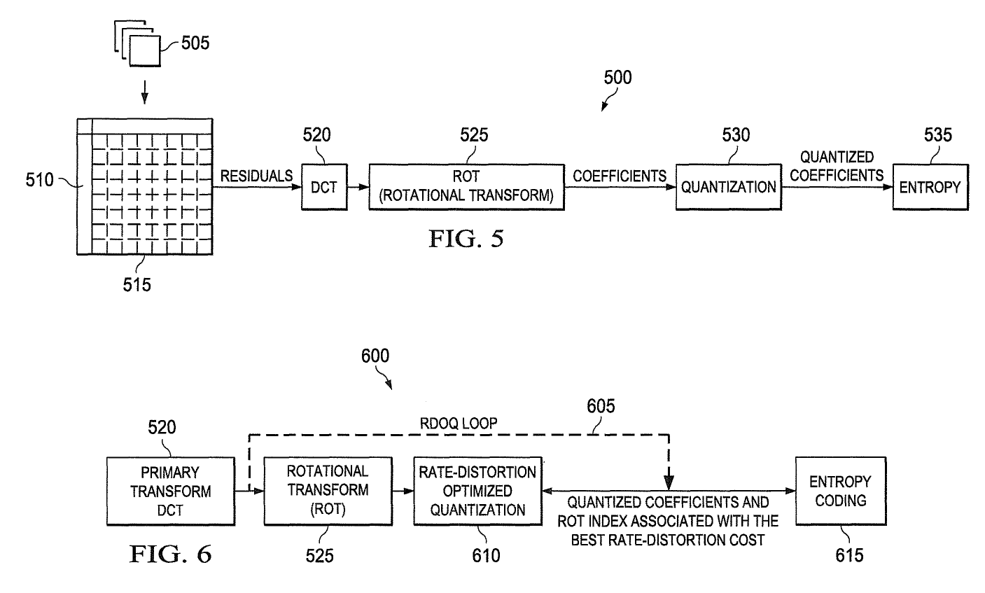

Furthermore, one or more of the base stations 101-103 may implement a video encoder configured to compress video information using at least a low complexity rotation transform. In certain embodiments, one or more of the base stations 101-103 includes a video encoder, as described with reference to FIGS. 5-8 below, configured to apply a rotational transform during the encoding process. Using the low complexity rotational transform encoding, such as a rotational transform (ROT) based secondary transform, further compresses the video information improving transmission efficiency.

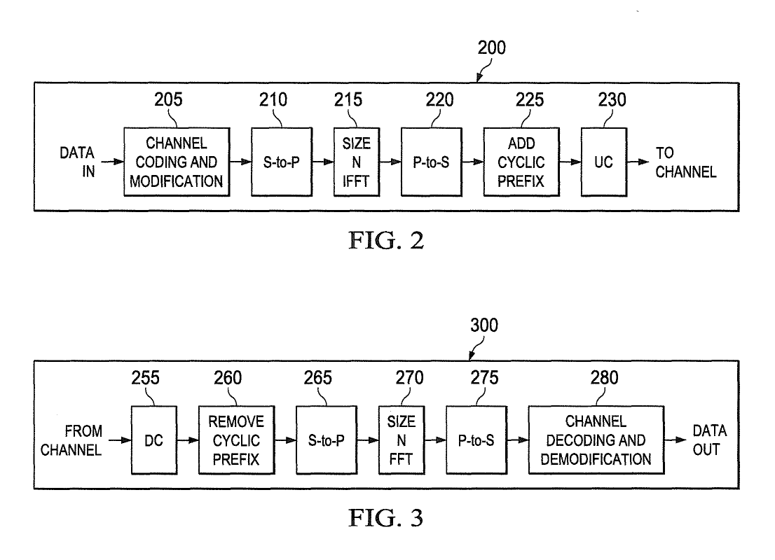

FIG. 2 is a high-level diagram of an orthogonal frequency division multiple access (OFDMA) transmit path. FIG. 3 is a high-level diagram of an OFDMA receive path. In FIGS. 2 and 3, the OFDMA transmit path 200 may be implemented, e.g., in base station (BS) 102 and the OFDMA receive path 300 may be implemented, e.g., in a subscriber station, such as subscriber station 116 of FIG. 1. It will be understood, however, that the OFDMA receive path 300 could be implemented in a base station (e.g. base station 102 of FIG. 1) and the OFDMA transmit path 200 could be implemented in a subscriber station.

Transmit path 200 comprises channel coding and modulation block 205, serial-to-parallel (S-to-P) block 210, Size N Inverse Fast Fourier Transform (IFFT) block 215, parallel-to-serial (P-to-S) block 220, add cyclic prefix block 225, up-converter (UC) 230. Receive path 300 comprises down-converter (DC) 255, remove cyclic prefix block 260, serial-to-parallel (S-to-P) block 265, Size N Fast Fourier Transform (FFT) block 270, parallel-to-serial (P-to-S) block 275, channel decoding and demodulation block 280.

At least some of the components in FIGS. 2 and 3 may be implemented in software while other components may be implemented by configurable hardware or a mixture of software and configurable hardware. In particular, it is noted that the FFT blocks and the IFFT blocks described in this disclosure document may be implemented as configurable software algorithms, where the value of Size N may be modified according to the implementation.

Furthermore, although this disclosure is directed to an embodiment that implements the Fast Fourier Transform and the Inverse Fast Fourier Transform, this is by way of illustration only and should not be construed to limit the scope of the disclosure. It will be appreciated that in an alternate embodiment of the disclosure, the Fast Fourier Transform functions and the Inverse Fast Fourier Transform functions may easily be replaced by Discrete Fourier Transform (DFT) functions and Inverse Discrete Fourier Transform (IDFT) functions, respectively. It will be appreciated that for DFT and IDFT functions, the value of the N variable may be any integer number (i.e., 1, 2, 3, 4, etc.), while for FFT and IFFT functions, the value of the N variable may be any integer number that is a power of two (i.e., 1, 2, 4, 8, 16, etc.).

In transmit path 200, channel coding and modulation block 205 receives a set of information bits, applies coding (e.g., LDPC coding) and modulates (e.g., Quadrature Phase Shift Keying (QPSK) or Quadrature Amplitude Modulation (QAM)) the input bits to produce a sequence of frequency-domain modulation symbols. Serial-to-parallel block 210 converts (i.e., de-multiplexes) the serial modulated symbols to parallel data to produce N parallel symbol streams where N is the IFFT/FFT size used in BS 102 and SS 116. Size N IFFT block 215 then performs an IFFT operation on the N parallel symbol streams to produce time-domain output signals. Parallel-to-serial block 220 converts (i.e., multiplexes) the parallel time-domain output symbols from Size N IFFT block 215 to produce a serial time-domain signal. Add cyclic prefix block 225 then inserts a cyclic prefix to the time-domain signal. Finally, up-converter 230 modulates (i.e., up-converts) the output of add cyclic prefix block 225 to RF frequency for transmission via a wireless channel. The signal may also be filtered at baseband before conversion to RF frequency.

The transmitted RF signal arrives at SS 116 after passing through the wireless channel and reverse operations to those at BS 102 are performed. Down-converter 255 down-converts the received signal to baseband frequency and remove cyclic prefix block 260 removes the cyclic prefix to produce the serial time-domain baseband signal. Serial-to-parallel block 265 converts the time-domain baseband signal to parallel time domain signals. Size N FFT block 270 then performs an FFT algorithm to produce N parallel frequency-domain signals. Parallel-to-serial block 275 converts the parallel frequency-domain signals to a sequence of modulated data symbols. Channel decoding and demodulation block 280 demodulates and then decodes the modulated symbols to recover the original input data stream.

Each of base stations 101-103 may implement a transmit path that is analogous to transmitting in the downlink to subscriber stations 111-116 and may implement a receive path that is analogous to receiving in the uplink from subscriber stations 111-116. Similarly, each one of subscriber stations 111-116 may implement a transmit path corresponding to the architecture for transmitting in the uplink to base stations 101-103 and may implement a receive path corresponding to the architecture for receiving in the downlink from base stations 101-103.

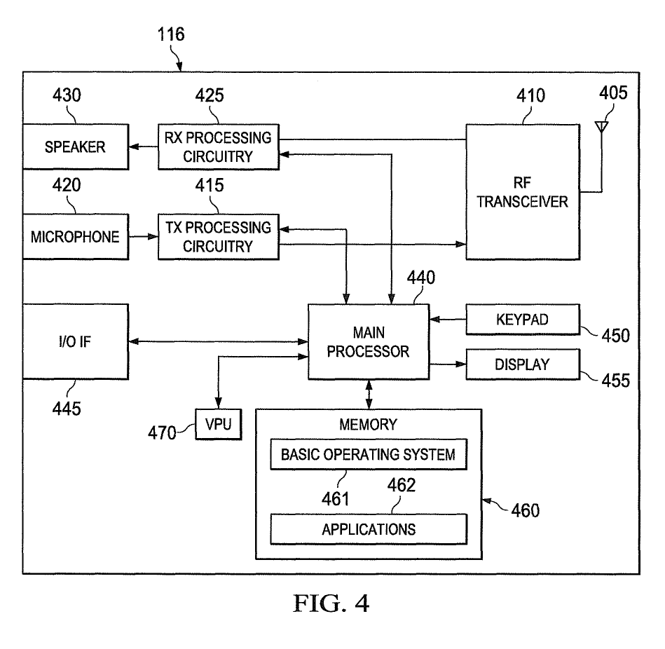

FIG. 4 illustrates an exemplary wireless subscriber station according to embodiments of the present disclosure. The embodiment of wireless subscriber station 116 illustrated in FIG. 3 is for illustration only. Other embodiments of the wireless subscriber station 116 could be used without departing from the scope of this disclosure.

Wireless subscriber station 116 comprises antenna 405, radio frequency (RF) transceiver 410, transmit (TX) processing circuitry 415, microphone 420, and receive (RX) processing circuitry 425. SS 116 also comprises speaker 430, main processor 440, input/output (I/O) interface (IF) 445, keypad 450, display 455, and memory 460. Memory 460 further comprises basic operating system (OS) program 461 and a plurality of applications 462. The plurality of applications can include one or more of resource mapping tables (Tables 1-10 described in further detail herein below).

Radio frequency (RF) transceiver 410 receives from antenna 405 an incoming RF signal transmitted by a base station of wireless network 100. Radio frequency (RF) transceiver 410 down-converts the incoming RF signal to produce an intermediate frequency (IF) or a baseband signal. The IF or baseband signal is sent to receiver (RX) processing circuitry 425 that produces a processed baseband signal by filtering, decoding, and/or digitizing the baseband or IF signal. Receiver (RX) processing circuitry 425 transmits the processed baseband signal to speaker 430 (i.e., voice data) or to main processor 440 for further processing (e.g., web browsing).

Transmitter (TX) processing circuitry 415 receives analog or digital voice data from microphone 420 or other outgoing baseband data (e.g., web data, e-mail, interactive video game data) from main processor 440. Transmitter (TX) processing circuitry 415 encodes, multiplexes, and/or digitizes the outgoing baseband data to produce a processed baseband or IF signal. Radio frequency (RF) transceiver 410 receives the outgoing processed baseband or IF signal from transmitter (TX) processing circuitry 415. Radio frequency (RF) transceiver 410 up-converts the baseband or IF signal to a radio frequency (RF) signal that is transmitted via antenna 405.

In some embodiments of the present disclosure, main processor 440 is a microprocessor or microcontroller. Memory 460 is coupled to main processor 440. According to some embodiments of the present disclosure, part of memory 460 comprises a random access memory (RAM) and another part of memory 460 comprises a Flash memory, which acts as a read-only memory (ROM).

Main processor 440 executes basic operating system (OS) program 461 stored in memory 460 in order to control the overall operation of wireless subscriber station 116. In one such operation, main processor 440 controls the reception of forward channel signals and the transmission of reverse channel signals by radio frequency (RF) transceiver 410, receiver (RX) processing circuitry 425, and transmitter (TX) processing circuitry 415, in accordance with well-known principles.

Main processor 440 is capable of executing other processes and programs resident in memory 460, such as operations for processing (such as decoding) video information using low complexity rotational transform encoding. Main processor 440 can move data into or out of memory 460, as required by an executing process. In some embodiments, the main processor 440 is configured to execute a plurality of applications 462, such as applications for low complexity rotational transform encoding. The main processor 440 can operate the plurality of applications 462 based on OS program 461 or in response to a signal received from BS 102. Main processor 440 is also coupled to I/O interface 445. I/O interface 445 provides subscriber station 116 with the ability to connect to other devices such as laptop computers and handheld computers. I/O interface 445 is the communication path between these accessories and main controller 440.

Main processor 440 is also coupled to keypad 450 and display unit 455. The operator of subscriber station 116 uses keypad 450 to enter data into subscriber station 116. Display 455 may be a liquid crystal display capable of rendering text and/or at least limited graphics from web sites. Alternate embodiments may use other types of displays.

In certain embodiments, SS 116 includes video processing unit 470. Video processing unit 470 can be a video encoder configured to perform an encoding process using low complexity rotational transform encoding as described with reference to FIGS. 5-8. Alternatively, Video processing unit 470 can be a video decoder configured to decode video information that was encoded using a low complexity rotational transform encoding as described with reference to FIGS. 5-8.

Embodiments of the present disclosure provide a system and method for efficiently processing video information for transmission and reception via wireless communications network 100. One of more of the base stations and subscriber stations include processing circuitry for encoding and decoding video information using low complexity rotational transform encoding. Using the low complexity rotational transform encoding, such as a rotational transform (ROT) based secondary transform, further compresses the video information improving transmission efficiency.

FIG. 5 illustrates an encoder that includes a rotational transform (ROT) based secondary transform according to embodiments of the present disclosure. The embodiment of the encoder 500 shown in FIG. 5 is for illustration only. Other embodiments could be used without departing from the scope of this disclosure. The encoder 500 can be an encoder 500 for use in a video transmission source, such as in BS 103. Alternatively, SS 116 can include a decoder configured with elements from encoder 500.

The encoder 500 is implemented in processing circuitry in one or both of BS 102 and SS 116 to improve the coding efficiency. The encoder 500 can be an encoder as described in U.S. patent application Ser. No. 13/242,981 to Felix Carlos Fernandes entitled “Low Complexity Secondary Transform For Image and Video Compression”, filed on Sep. 23, 2011, the contents of which are hereby incorporated by reference in their entirety. Video information can be generated in multiple frames 505 and formats. For example, the video information can generated at 720 pixels per 30 Hz (e.g., thirty frames per second). Each frame 505 can be divided into blocks of 8×8, 16×16, 32×32, 64×64, or N×N. The video information is processed by a prediction in the processing circuitry to determine predictions and output residuals 515. That is, the prediction outputs a prediction mode and associated residual block. For example, for each block 505, the upper block and the left block 510 are used to determine the predictions. The prediction comprises a core or contour of the image in the frame. After the prediction, the video information is squeezed (compressed).

The processing circuitry then applies a primary transform to the residuals output from the prediction. For example, the residuals are received by the primary transform, which can be a discrete cosine transform (DCT) 520. The DCT 520 on is applied to residuals (blocks) and outputs a corresponding set of coefficients. For example, when the DCT 520 is applied to a block that is eight pixels wide by eight pixels high, the DCT 520 operates on sixty-four input pixels and yields sixty-four frequency-domain coefficients. The DCT 520 preserves all of the information in the eight-by-eight image block. Therefore, the DCT 520 receives and compresses video information and outputs compressed video information corresponding to the received video information, the compressed video information comprising a transform block and associated prediction modes. That is, the DCT 520 receives residuals from prediction circuit and performs the primary transform. Then, DCT 520 can output a transform coefficient block and associated transform size.

The output of the DCT 520 is sent to a second transform, which is a ROT 525. The ROT 525 generates a plurality of output coefficients, or transform coefficients, that are sent to a quantization block 530, which generates quantized coefficients. The quantization block 530 performs quantization on the compressed video information and an associated secondary transform index output from the ROT 525. The quantization block 530 outputs, to an entropy encoding block 535, the compressed video information into quantized transform coefficients and associated quantization parameter. The entropy encoding block 535 converts the output of the quantization block 530 into a binary code suitable for reading and decoding by a receiver. Meanwhile, the current coded image or frame is reconstructed for temporal prediction. The filtering stage is configured to filter and improve the reconstructed video information.

The transform block, which is output from the DCT 520, includes a low frequency area and a high frequency area. The ROT 525 is configured to move non-zero coefficients in the high frequency area to the low frequency area. When compressing non-zero coefficients that occur in the low frequency area, then coding efficiency is high. However, when non-zero coefficients occur in the in high frequency area, coding efficiency is low.

FIG. 6 illustrates an encoder that includes a ROT with rate-distortion optimized quantization (RDOQ) loop according to embodiments of the present disclosure. The encoder 600 shown in FIG. 6 is for illustration only. Other encoders could be used without departing from the scope of this disclosure. The encoder 600 can be an encoder 600 for use in a video transmission source, such as in BS 103. Alternatively, SS 116 can include a decoder configured with elements from encoder 600.

In certain embodiments, to include the ROT 525 as secondary transform, the ROT 525 is embedded inside the RDOQ loop 605. In order to more efficiently squeeze the energy after primary transform (e.g., DCT 520), the encoder 600 performs multiple rotational transforms (corresponding to different rotational angles). For example, when N is the number of rotational transforms, the encoder 600 includes (N+1) loops. Having N+1 loops can impose significant computational complexity demands, which may not be practical for application purposes. In the RDOQ loop 605, after the ROT 535 applies one of the different rotational transforms, a quantization block 610 performs a rate-distortion Optimized Quantization, such as H.264/AVC and on-going Moving Picture Experts Group (MPEG) high efficiency video coding (HEVC) to improve coding efficiency.

In certain embodiments, the encoder 600 is configured to perform low complexity splitting, which is also called RDOQ loop splitting. In low complexity splitting, the encoder is configured to leverage the characteristics of ROT transform and break the RDOQ loop 605. The encoder 600 is configured to perform RDOQ loop splitting to avoid multiple RDOQ process for the same block.

In certain embodiments, the encoder 600 is configured to perform five rotational iterations. In each iteration, ROT 525 applies a different rotation to the output of the DCT 520. That is, a first rotation is applied to the compressed video information during a first iteration and a second rotation is applied to the compressed video information during a second iteration. One or more of the ROT 525 and the RDOQ 610 determines a best result of the five iterations. That is, One or more of the ROT 525 and the RDOQ 610 determines which of the five outputs from the respective different rotations applied by the ROT 525 yields the optimal results.

FIG. 7 illustrates an m×m block based rotational transform on an M×M transform block according to embodiments of the present disclosure. The embodiment of the transform block 700 shown in FIG. 7 is for illustration only. Other embodiments could be used without departing from the scope of this disclosure.

The ROT is applied at the upper-left block 705 of the transform block 700, where M can be 32, 16, 8 and 4, and m can be 8 and 4. The upper-left block 705 corresponds to the high frequency area of the transform block 700. In addition, a lower-right portion of the transform block 700 defines the high frequency area. For example, assuming M=16 and m=8, an 8×8 block based ROT is applied on the upper-left 8×8 block 705 for each 16×16 transform block 700. For each RDOQ loop, the ROT 525 applies a different ROT to upper-left 8×8 block 705. The ROT 525 applies the different ROT only to the upper-left 8×8 block 705. Hence only coefficients inside upper-left 8×8 block 705 are modified while the rest of the coefficients are kept as the same.

After applying the ROT, different scanning pattern is used to scan the two-dimensional (2-D) coefficients into a one-dimensional (1-D) vector for quantization in RDOQ block 610 and entropy encoding block 615. The scanning can be popular zigzag, horizontal, vertical, diagonal and other specialized patterns.

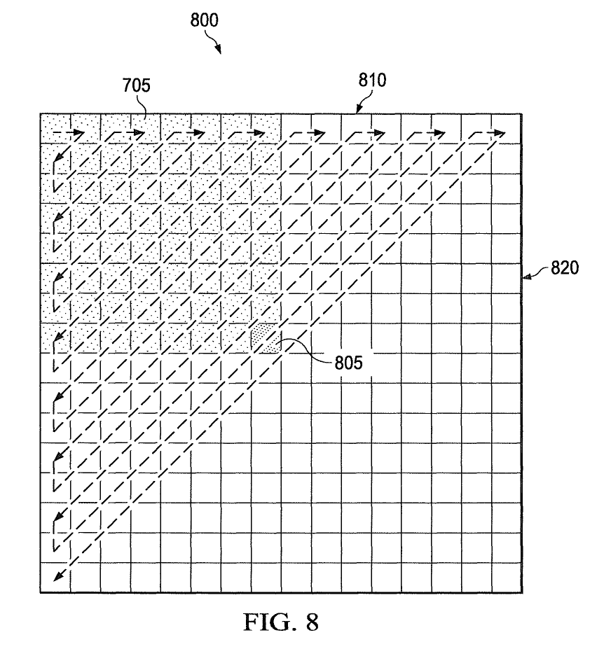

FIG. 8 illustrates an example zig-zag scanning on a 16×16 block according to embodiments of the present disclosure. In the following context, zigzag scanning is used as an example to demonstrate an embodiment of the present disclosure. Other embodiments can utilize other scanning pattern without departing from the scope of this disclosure.

In certain embodiments, the zigzag pattern is used to scan coefficients after ROT 525 to form a 1-D vector. The coefficients will not be changed after a certain cut-off position 805. This cut-off position 805 depends on the rotational transform block size. For example, when ROT 525 utilizes a 8×8 ROT, the cut-off position is as shown in FIG. 8. Since there is only ROT applied on upper-left block 705, no coefficient changes occur between RDOQ loops. Therefore, the large block 800 is split into two sub blocks 810, 820 at cut-off position 805, where the first block, which will be affected by ROT 525, is defined as ROT block 810, and the other is defined as non-ROT block 820.

In certain embodiments, the non-ROT block 820 is encoded at once and the necessary states are stored. The necessary states include distortion, rate-distortion cost, quantized transform coefficients (levels and runs), context models, and the like. Multiple encoding is only applied on ROT block 810 where coefficients will be changed by each ROT loop 605.

The cut-off position 805 is block size and scanning method dependent. FIG. 8 illustrates a zigzag and 8×8 ROT as an example. However, embodiments of the present disclosure can be applied to any type of scanning scheme and different ROT blocks. Furthermore, the coefficient or pixel based RDOQ block splitting illustrated in FIG. 8 can be applied to block based splitting as well.

In certain embodiments, the encoder 600 is configured to use ROT only for a best prediction mode. In video coding, many block prediction modes are used to exploit the spatial redundancy. For example, thirty-three prediction modes are used in MPEG HEVC. Applying the thirty-three prediction modes to the five iterations performed by the encoder 600 yields 33*5=165 times iteration for a block coding.

In certain embodiments, the encoder 600 is configured to decouple the ROT and & block prediction mode decision. The encoder 600 then applies the ROT on the best prediction mode only. That is, the encoder 600 does not apply the ROT to a normal prediction mode. For such proposal, the block coding iteration is reduced from 165 to 37 (which is 33+4).

In one example implementation, a decoder 600 that utilizes a low-complexity ROT encoding is compared with a conventional HM rotational transform as discussed in JCT-VC, “Test Model under Consideration”, JCTVC-E205, Joint Collaborative Team on Video Coding meeting, March 2011, Geneva, Switzerland. To test the encoder 600, the anchor is HM (F. Bossen, “Common test conditions and software reference configurations,”, JCTVC-E600, March 2010, Geneva, Switzerland) using different configuration files, including intra high-efficiency (IHE) encoder_intra.cfg, intra low-complexity encoder_intra_loco.cfg, random access high efficiency encoder_random.cfg and random access low complexity encoder_random_loco.cfg. For the test case, the same settings as the anchor are used, but the original ROT and proposed reduced-complexity ROT encoding implementation are applied. Both encodings use the full test with all frames of Class A-E CfP test-sequences. Simulation results are shown in Table I and II. Table I and II illustrated that the encoder 600 reduces the encoding complexity significantly (IHE: 5%, ILC 15%) but without performance loss.

TABLE I
Coding Efficiency and Complexity for
HM3.0 with Conventional ROT encoding.

| | Intra | | | Intra LoCo | | |
|---|---|---|---|---|---|---|
| | Y BD- | U BD- | V BD- | Y BD- | U BD- | V BD- |
| | rate | rate | rate | rate | rate | rate |
| Class A | −1.1 | 0.2 | 0.1 | −1.3 | 0.0 | −0.3 |
| Class B | −1.2 | 0.6 | 0.6 | −1.3 | 0.6 | 0.6 |
| Class C | −0.7 | 0.4 | 0.4 | −0.8 | 0.3 | 0.3 |
| Class D | −0.6 | 0.5 | 0.6 | −0.8 | 0.3 | 0.4 |
| Class E | −0.8 | 0.2 | 0.3 | −1.0 | 0.3 | 0.3 |
| All | −0.9 | 0.4 | 0.4 | −1.0 | 0.3 | 0.3 |
| Enc | 130% | | | 171% | | |
| Time[%] | | | | | | |
| Dec | 101% | | | 101% | | |
| Time[%] | | | | | | |
| | Random access | | | Random access LoCo | | |
| | Y BD- | U BD- | V BD- | Y BD- | U BD- | V BD- |
| | rate | rate | rate | rate | rate | rate |
| Class A | −0.5 | 0.2 | 0.2 | −0.7 | −0.8 | −0.6 |
| Class B | −0.7 | 0.3 | 0.6 | −0.7 | 0.2 | 0.2 |
| Class C | −0.5 | 0.2 | 0.0 | −0.5 | 0.1 | −0.1 |
| Class D | −0.4 | 0.2 | −0.1 | −0.5 | −0.2 | 0.2 |
| Class E | | | | | | |
| All | −0.5 | 0.2 | 0.2 | −0.6 | −0.1 | 0.0 |

| | | |
|---|---|---|
| Enc | 106% | 107% |
| Time[%] | | |
| Dec | 100% | 100% |
| Time[%] | | |

TABLE II
Coding Efficiency and Complexity for HM3.0
with RDOQ loop splitting using encoder 600.

| | Intra | | | Intra LoCo | | |
|---|---|---|---|---|---|---|
| | Y BD- | U BD- | V BD- | Y BD- | U BD- | V BD- |
| | rate | rate | rate | rate | rate | rate |
| Class A | −1.1 | 0.2 | 0.2 | −1.3 | 0.1 | −0.3 |
| Class B | −1.2 | 0.7 | 0.7 | −1.3 | 0.6 | 0.5 |
| Class C | −0.7 | 0.4 | 0.4 | −0.8 | 0.3 | 0.3 |
| Class D | −0.6 | 0.5 | 0.5 | −0.7 | 0.3 | 0.4 |
| Class E | −0.8 | 0.2 | 0.2 | −1.0 | 0.3 | 0.3 |
| All | −0.9 | 0.4 | 0.4 | −1.0 | 0.4 | 0.3 |
| Enc | 126% | | | 156% | | |
| Time[%] | | | | | | |
| Dec | 101% | | | 100% | | |
| Time[%] | | | | | | |
| | Random access | | | Random access LoCo | | |
| | Y BD- | U BD- | V BD- | Y BD- | U BD- | V BD- |
| | rate | rate | rate | rate | rate | rate |
| Class A | −0.5 | 0.2 | 0.0 | −0.7 | −0.5 | −0.4 |
| Class B | −0.7 | 0.4 | 0.5 | −0.7 | 0.2 | 0.2 |
| Class C | −0.5 | 0.2 | 0.0 | −0.5 | 0.1 | −0.1 |
| Class D | −0.4 | 0.2 | −0.1 | −0.5 | −0.2 | 0.1 |
| Class E | −0.0 | 0.0 | 0.0 | | | |
| All | −0.5 | 0.2 | 0.1 | −0.6 | −0.1 | 0.0 |

| | | |
|---|---|---|
| Enc | 105% | 105% |
| Time[%] | | |
| Dec | 101% | 99% |
| Time[%] | | |

To provide an encoding restriction that allows shorter execution times with lowered coding gain, consider the following pseudo code from JCT-VC, “Test Model under Consideration”, JCTVC-E205, Joint Collaborative Team on Video Coding meeting, March 2011, Geneva, Switzerland, the contents of which are hereby incorporated by reference. This pseudo code describes the rate-distortion optimized search for optimal intra prediction mode and ROT index.

bestROTindex = −1
bestIntraMode = −1
rdCostMin = INT_MAX
for i in Intra_Pred_Mode_Candidate_Set
for j in ROT_Dictionary

rdCost = getRDcost(i, j)
if rdCost < rdCostMin

rdCostMin = rdCost
bestIntraMode = i
bestROTindex = j

It can be observed that this pseudo code incurs long execution times because |Intra_Pred_Mode_Candidate_Set|*|ROT_Dictionary| iterations occur, where ∥ indicates set multiplicity. In contrast, embodiments of the present disclosure utilize a method in which the intra prediction mode search is decoupled from the ROT index search. For example, the ROT code below is:

bestIntraMode = −1
rdCostMin = INT_MAX
for i in Intra_Pred_Mode_Candidate_Set

rdCost = getRDcost (i, 0)
if rdCost < rdCostMin

```
  rdCostMin = rdCost
  bestIntraMode = i
```

bestROTindex = −1
rdCostMin = INT_MAX

for j in ROT_Dictionary

rdCost = getRDcost(bestIntraMode, j)
if rdCost < rdCostMin

```
  rdCostMin = rdCost
  bestROTindex = j
```

Utilizing the ROT code, shorter execution times occur since only |Intra_Pred_Mode_Candidate_Set|+|ROT_Dictionary| iterations occur.

To improve ROT signaling efficiency, BS 103 or SS 116, or both, utilize an efficient ROT BIT encoding. The processing circuitry in BS 103 or SS 116 maintains a histogram to count the usage frequency for ROT indices 0, 1, 2, 3, 4 where index 0 is the trivial ROT and indices 1, 2, 3, 4 are non-trivial ROT indices. This histogram is updated after the ROT index for each coding unit is finalized. To signal the ROT index, three bits, C2, C1, C0, are used. Bit C2 indicates whether the ROT index is the highest frequency entry in the histogram. If it is, then Bits C1 and C0 are not required and only one bit is required for signaling. However, if Bit C2 indicates that the ROT index is not the histogram's highest frequency entry, then bits C1 and C0 specify the ROT index from the four options in the set obtained by excluding the histogram's highest frequency entry from the set {0, 1, 2, 3, 4}. Accordingly, in certain embodiments, only one bit to is required to signal the highest frequency ROT index. Therefore, the efficient ROT BIT encoding improves over the prior art which is efficient only when the trivial ROT occurs with highest frequency.

TABLE III
ROT Index

| ROT Index | BIT |
|---|---|
| 0 | 0 |
| 1 | 100 |
| 2 | 101 |
| 3 | 110 |
| 4 | 111 |

In addition to RDOQ loop splitting, in certain embodiments, a ROT index prediction can be incorporated.

To increase the coding efficiency from data hiding, high coding gain is obtained by hiding the ROT on/off bit as explained below. There are two embodiments to achieve a high coding gain.

In a first embodiment, the Rate-Distortion (RD) intermediate and final costs associated with each ROT index are computed and saved in a loop that iterates over all indices in the ROT dictionary. The ROT index with the lowest final cost is selected and then the associated transform coefficients are examined (for example, check the sum of absolute transformed coefficients and ROT index) to select the RD-optimal coefficient in which to hide the ROT on/off bit.

In the second embodiment, the Rate-Distortion (RD) intermediate and final costs associated with each ROT index are computed and saved in a loop that iterates over all indices in the ROT dictionary. In each iteration, the transform coefficients associated with the particular ROT index are examined to select the RD-optimal coefficient in which to hide the ROT on/off bit. This embodiment will have higher coding efficiency than the first embodiment because the data-hiding RD-cost is accounted for during ROT index selection. However, computational complexity will be slightly higher than the first embodiment as a result of the data hiding cost being computed for each ROT index in the dictionary.

In an alternative embodiment, ROT signaling efficiency can be improved as follows. Bits D3, D2, D1, D0 signal the ROT index. Bit D3 indicates whether the ROT index is the histogram's highest frequency entry. If so, then only one bit is required for signaling. If not, then Bit D2 indicates whether the ROT index is the histogram's second-highest frequency entry. If so, then only two bits are required for signaling. If not, then Bit D1 indicates whether the ROT index is the histogram's third-highest frequency entry. If so, then three bits are used for signaling. If not, then Bit D0 specifies the ROT index from the two options in the set obtained by excluding the histogram's three highest frequency entries from the set {0, 1, 2, 3, 4}. Utilizing this embodiment, the encoder 600 improves over prior art systems significantly when the three highest frequency entries in the histogram occur as ROT indices much more frequently than the other entries. In this case, only one, two or three bits are required for signaling most coding units, whereas the prior art systems require 1 or 3 bits. On average, this method will produce a shorter bits requirement over existing systems.

The encoder 600 reduces the computational complexity and maintains coding efficiency. The encoder 600 implements the ROT scheme with reasonable encoder complexity and high coding efficiency.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A video processing system comprising:
a prediction and primary transform configured to receive and compress video information and output compressed video information corresponding to the received video information, the compressed video information comprising a transform block and associated prediction modes;
a secondary transform configured to receive and compress the compressed video information and produce a set of output coefficients;
a quantization and entropy coding stage configured to convert the set of output coefficients into binary format; and
a filtering stage configured to improve reconstructed video information.

2. The video processing system as set forth in claim 1, further comprising a quantization block configured to perform a rate-distortion optimized quantization.

3. The video processing system as set forth in claim 2, wherein the secondary transform and the quantization block are configured as a rate-distortion optimized quantization (RDOQ) loop configured to apply rotational transform iterations to transform coefficients outputted from primary transform.

4. The video processing system as set forth in claim 2, wherein the secondary transform and the quantization block are configured to perform five rotational iterations, wherein in each iteration, the secondary transform is configured to apply a different rotation to the compressed video information and wherein the secondary transform is configured to determine a best result of the five iterations.

5. The video processing system as set forth in claim 2, wherein the RDOQ loop is configured to split the transform block into a first portion and a second portion, wherein the RDOQ loop is further configured to apply the rotational transform to the first portion and a single rate-distortion optimized quantization to the second portion.

6. The video processing system as set forth in claim 1, wherein the RDOQ loop is configured to apply the secondary transform only to a best prediction mode.

7. The video processing system as set forth in claim 1, wherein the processing circuitry is configured to store a plurality of secondary transform indices and signal at least one rotational index using at least one of three bits, the three bits comprising C2, C1 and C0.

8. The video processing system as set forth in claim 7, wherein C2 is configured to indicate whether a secondary transform index is a highest frequency entry,
when the secondary transform index corresponds to the highest frequency entry, only one bit is required for signaling, and
when the secondary transform index does not correspond to the highest frequency entry, C1 and C0 specify the secondary transform index from one of four options in a set obtained by excluding the highest frequency entry from a set {0, 1, 2, 3, 4}.

9. The video processing system as set forth in claim 8, wherein C2 is configured to indicate whether the secondary transform index is the highest frequency entry and further configured as the secondary transform ON/OFF bit, wherein:
when transformed coefficients are examined and satisfy a corresponding secondary transform, C2 is not transmitted; and
when the transformed coefficients are examined and do not satisfy the corresponding secondary transform, the transform coefficients are configured to be changed to satisfy a C2 bit hiding requirement such that an even number corresponds to C2=0 and an odd number corresponds to the C2=1.

10. A method for video processing system comprising:
compressing, by a prediction, video information, the compressed video information comprising a prediction mode and associated residual block;
compressing, by a primary transform, video information, the compressed video information comprising a transform coefficient block and an associated transform size;
compressing, by a secondary transform, the compressed video information and an associated secondary transform index;
compressing, by a quantization, the compressed video information into quantized transform coefficients and associated quantization parameter;
converting, by a entropy coding stage, the compressed video information into binary format; and
filtering, by a filtering stage, reconstructed video information.

11. The method as set forth in claim 10, further comprising performing a rate-distortion optimized quantization.

12. The method as set forth in claim 11, wherein the secondary transform and the quantization block are configured as a rate-distortion optimized quantization (RDOQ) loop, and wherein compressing the compressed video information further comprises:
applying secondary transform iterations to the compressed video information.

13. The method as set forth in claim 11, wherein compressing the compressed video information further comprises:
performing five secondary iterations, wherein in each iteration comprises, applying, by the secondary transform, a different rotation to the compressed video information; and
determining a best result of the five iterations.

14. The method as set forth in claim 11, further comprising:
splitting the transform block into a first portion and a second portion; and
applying the secondary transform to the first portion and a single rate-distortion optimized quantization to the second portion.

15. The method as set forth in claim 10, wherein compressing the compressed video information further comprises applying the secondary transform only to a best prediction mode.

16. The method as set forth in claim 10, further comprising:
storing a plurality of secondary indices; and
signaling at least one secondary index using at least one of three bits, the three bits comprising C2, C1 and C0.

17. The method as set forth in claim 16, wherein C2 is configured to indicate whether the at least one of secondary transform index is a highest frequency entry,
when a secondary transform index corresponds to the highest frequency entry, only one bit is required for signaling, and
when the secondary transform index does not correspond to the highest frequency entry, C1 and C0 specify the secondary transform index from one of four options in a set obtained by excluding the highest frequency entry from a set {0, 1, 2, 3, 4}.

18. The method as set forth in claim 17, wherein C2 is configured to indicate whether the secondary transform index is the highest frequency entry and further configured as the secondary transform ON/OFF bit, wherein
when transformed coefficients are examined and satisfy a corresponding secondary transform, C2 is not transmitted; and
when the transformed coefficients are examined and do not satisfy the corresponding secondary transform, transform coefficients are configured to be changed to satisfy a C2 bit hiding requirement such that an even number corresponds to C2=0 and an odd number corresponds to the C2=1.

19. A video transmission system comprising:
an encoder configured to compress video information, the encoder comprising:
a predication and primary transform configured to receive and compress the video information and output compressed video information corresponding to the received video information, the compressed video information comprising a predication mode and a transform block,
a secondary transform configured to receive and compress the compressed video information and produce a set of transform coefficients,
a quantization stage configured to receive and compress the transform coefficients into quantized coefficients, and
an entropy coding stage configured to convert the compressed video information into binary format; and
a transmitter configured to transmit a binary stream outputted from the encoder.

20. The video transmission system as set forth in claim 19, further comprising a quantization block configured to perform a rate-distortion optimized quantization.

21. The video transmission system as set forth in claim 19, wherein the secondary transform and the quantization block are configured as a rate-distortion optimized quantization (RDOQ) loop configured to apply a first rotational angle to the compressed video information during a first iteration and a second rotational angle to the compressed video information during a second iteration.

22. The video transmission system as set forth in claim 20, wherein the secondary transform and the quantization block are configured to perform five rotational iterations, wherein in each iteration, the secondary transform applies a different rotation to the compressed video information and wherein the secondary transform is configured to determine a best result of the five iterations.

23. The video transmission system as set forth in claim 20, wherein the RDOQ loop is configured to split the transform block into a first portion and a second portion, wherein the RDOQ loop is further configured to apply the secondary transform to the first portion and a single rate-distortion optimized quantization to the second portion.

24. The video transmission system as set forth in claim 19, wherein the RDOQ loop is configured to apply the secondary transform only to a best prediction mode.

25. The video transmission system as set forth in claim 19, wherein the processing circuitry is configured to store a plurality of secondary transform indices and signal at least one secondary transform index using at least one of three bits, the three bits comprising C2, C1 and C0.

26. The video transmission system as set forth in claim 25, wherein C2 is configured to indicate whether the at least one secondary transform index is the highest frequency entry,
when a secondary transform index corresponds to the highest frequency entry, only one bit is required for signaling, and
when the secondary transform index does not correspond to the highest frequency entry, C1 and C0 specify the secondary transform index from one of four options in a set obtained by excluding the highest frequency entry from a set {0, 1, 2, 3, 4}.

27. The video transmission system as set forth in claim 26, wherein C2 is configured to indicate whether the secondary transform index is the highest frequency entry and further configured to as the secondary transform ON/OFF bit, wherein
when transformed coefficients are examined and satisfy a corresponding secondary transform, C2 is not transmitted; and
when the transformed coefficients are examined and do not satisfy the corresponding secondary transform, the transform coefficients are configured to be changed to satisfy a C2 bit hiding requirement such that an even number corresponds to C2=0 and an odd number corresponds to the C2=1.
